(19) United States
(12) Patent Application Publication
(10) Pub. No.: US 2012/0198252 A1
(43) Pub. Date: Aug. 2, 2012

(54) System and Method for Managing and Detecting Server Power Connections

(76) Inventors: Phillip M. Kirschtein, New Market, AL (US); Steven Blackwell, Huntsville, AL (US); Ashish Moondra, Madison, AL (US)

(21) Appl. No.: 13/018,805

(22) Filed: Feb. 1, 2011

(51) Int. Cl. G06F 1/28; G06F 1/26

(52) U.S. Cl. 713/310

(57) ABSTRACT

An enhanced remote power switch includes a communications interface for sending and receiving messages to control the power applied to a power cord, thereby turning on/off a target server. The power cord is connected to the target server at the target server end by use of a bonding device. A rack interface pod (RIP) or other monitoring device also can be connected to the target server by way of another bonding device. The bonding device can be wrapped around or connected to the keyboard, video or mouse (KVM) cable(s) connecting the target server and the monitoring device to ensure that the target server does not unintentionally get associated with a different monitoring device than it had initially been paired with. In addition, at least one data port of the remote power switch is in communication with an information tag to help identify the target servers attached to the power switch.

### FIELD OF INVENTION

The present invention is directed to a system and method for detecting cabling configurations in a computer server management environment, and in one embodiment to detecting to which power outlets in a rack configuration the corresponding servers are connected.

### DISCUSSION OF THE BACKGROUND

Historically, system administrators and/or network engineers have had to spend considerable effort to maintain the cabling correlation between a Remote Power Switch and the corresponding Server Management System ports. This information is helpful in determining which power outlet should be remotely cycled in order to cold boot a selected server. For example, as shown in FIG. 1, a remote power switch 100 can receive a command from a communications channel over a communications interface (e.g., a serial port or LAN) which requests that the remote power switch cycle power to one of its outlets to which the power cords (125a-125d) are connected. By cycling the AC power transmitted over the power cords (125a-125d) off and then on again, the connected target server 120 will be rebooted. However, with out-of-date or erroneous information, a remote system administrator or network engineer could inadvertently cut power to the wrong target server, thereby not only failing to reboot the intended target server but also rebooting an unintended target server.

### BRIEF DESCRIPTION OF THE DRAWINGS

The following description, given with respect to the attached drawings, may be better understood with reference to the non-limiting examples of the drawings, wherein:

FIG. 1 is block diagram of a conventional remote power switch connected by corresponding power cords to a series of target servers;

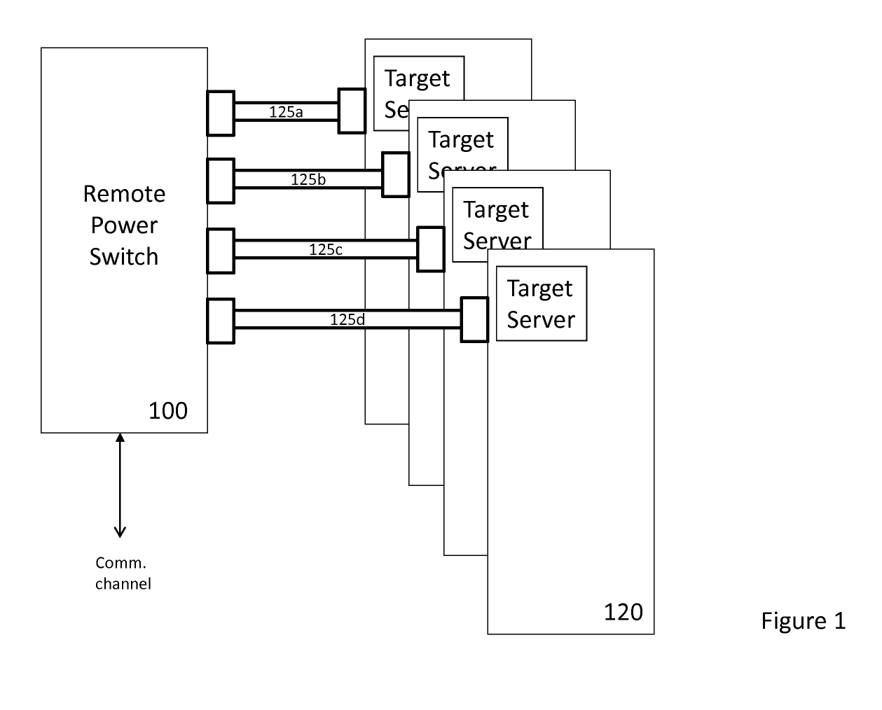

FIG. 2A is a block diagram of an exemplary enhanced remote power switch including a specialized communications connector and an information tag which enable a system administrator to identify a target server connected to an outlet of the enhanced remote power switch;

FIG. 2B is a block diagram of an exemplary enhanced remote power switch including a specialized communications connector and an information tag which enable a system administrator to identify a target server connected to an outlet of the enhanced remote power switch;

FIGS. 3A and 3B are block diagrams of target servers including attachment points for a bonding device;

FIG. 4 is an enlarged block diagram of the enhanced remote power switch shown in FIGS. 2A and 2B;

FIG. 5 is a block diagram of internal components of the information tag of FIGS. 2A, 2B and 4;

FIG. 6 is a block diagram of an enhanced remote power switch utilizing a combined data connector and information tag attached around the power cord connected to an outlet of the enhanced remote power switch;

FIG. 7 is a block diagram of an enhanced remote power switch utilizing a combined data connector and information tag attached to a flange of the power cord connected to an outlet of the enhanced remote power switch; and

FIG. 8 is a block diagram of an enhanced remote power switch communicating with an information tag within a rack interface pod.

### DISCUSSION OF THE PREFERRED EMBODIMENTS

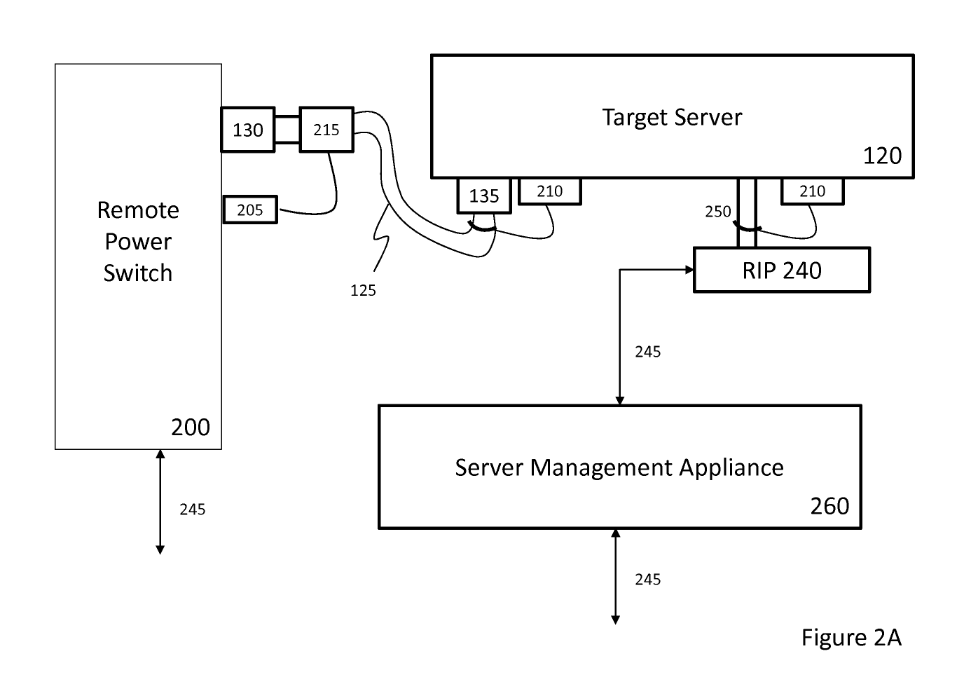

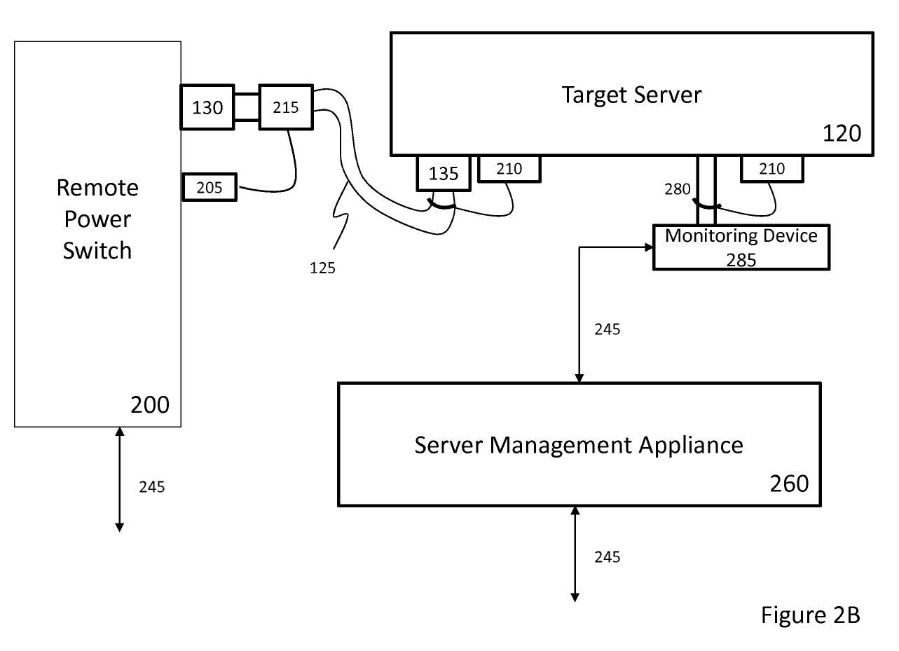

Turning to FIG. 2A, an enhanced remote power switch 200 includes a communications interface for sending and receiving information across a communications channel (e.g., a serial channel (such as RS-232 or a USB), a parallel channel, or a packet-switched communications channel (e.g., an Ethernet channel)) utilizing a communications protocol (e.g., IP, IPX, TCP/IP, or UDP/IP). From the communications channel, the remote power switch 200 receives messages (e.g., from a computer of a network administrator, an integrated server management software environment, or from a server management appliance 260) to control the power applied to a power cord 125, thereby turning on/off a target server 120. The power cord 125 is physically attached to the target server 120 at the target server end by use of a bonding device 210. The bonding device 210 can be any mechanical device which prevents the power cord 125 from being disassociated from the AC port of the target server 120 and connected to another target server. (The bonding device 210 does not need to keep the power cord from being removed from the AC port of the target server 120 as it may be necessary to unplug a target server when performing maintenance on or changing internal components of the target server. The power cord need only remain sufficiently connected to the target server to avoid it being mistakenly connected to a different target server than that with which it was originally paired.)

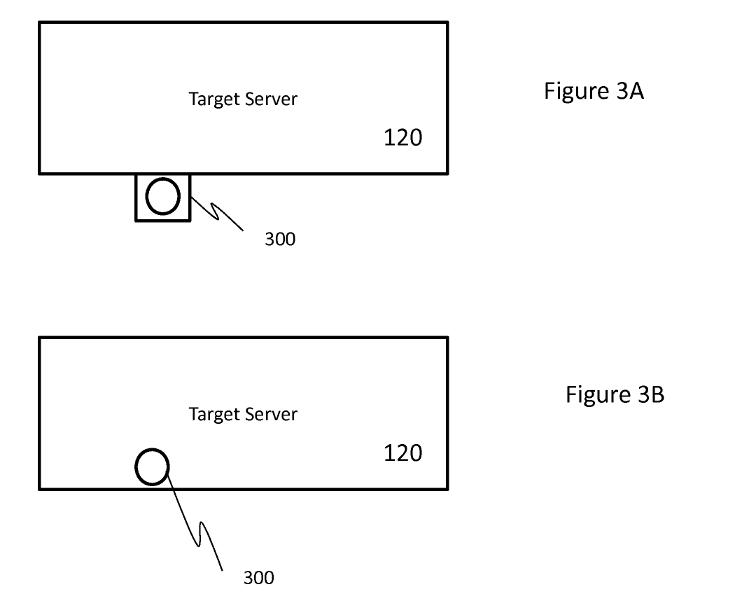

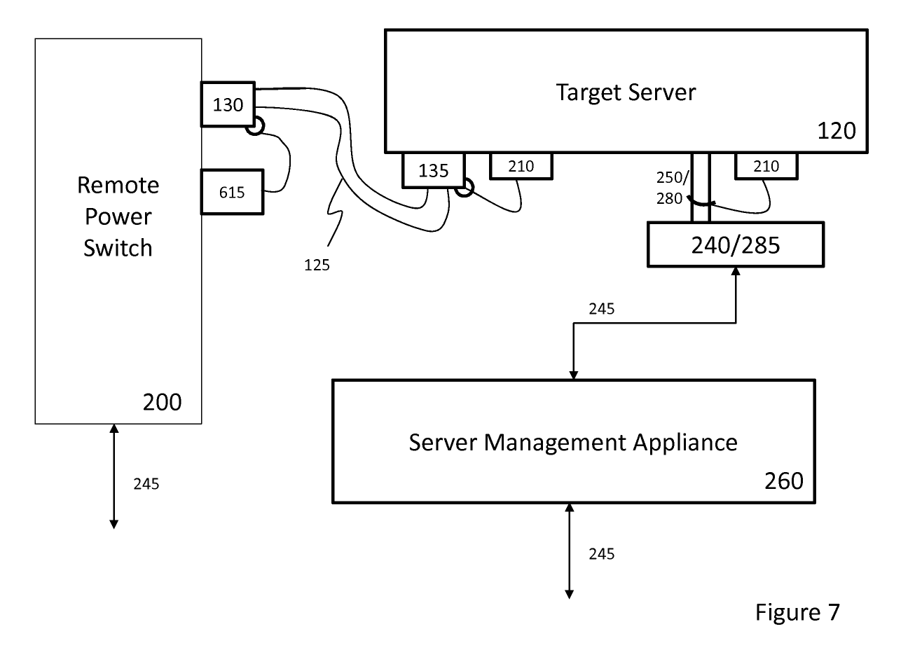

For example, the bonding device 210 can be a mechanical bonding device (e.g., tie wrap) that wraps around the power cord 125 and connects to the target server 210 (e.g., through an opening 300 in a flange on the target server, as shown in FIG. 3A, or through an opening 300 in the case of the target server itself). Alternatively, the bonding device may be a screw-in device that screws into the target server and wraps around the power cord 125. In yet another embodiment, as shown in FIG. 7, the power cord may include a mounting device (e.g., a flange) at the target server end of the power cord that can receive a tie wrap or cable tie that also connects to the target server (e.g., using an opening in a flange or case or an adhesive tie wrap mount).

Similarly, a rack interface pod (RIP) 240 can be connected to the target server 120 by way of another bonding device 210. The bonding device can be wrapped around or connected to the keyboard, video or mouse (KVM) cable(s) 250 connecting the target server 120 and the RIP 240 to ensure that the target server 120 does not unintentionally get associated with a different RIP 240 than that with which it was originally paired. The KVM cables may include separate connections for the keyboard and mouse or may use a single connection for the keyboard and mouse (e.g., when using a USB interface).

A target server monitoring device other than a RIP can likewise be attached to a target server. As shown in FIG. 2B, a monitoring device 285 (e.g., an Avocent MergePoint SPM5324 or a console server such as an Avocent ACS6000) can be connected by a corresponding cable 280 (e.g., an Ethernet cable for the Avocent MergePoint SPM5324 or a serial cable for a console server such as the Avocent ACS6000). The monitoring device 285 is then either configured to communicate with a server management appliance 260 (which communicates with the remote power switch 200 as described in greater detail below) or is configured to communicate with the remote power switch 200 itself. As used herein, a RIP 240 is also a “target server monitoring device.”

In a configuration such as is shown in FIG. 2A, when power is applied to a target server 120 from the remote power switch 200 across a power cord 125, a RIP 240 connected to the target server 120 will become operational since it is powered by target server 120. Once powered, RIP 240 will be able to communicate with the server management appliance 260 over a communications channel 245. (For example, if the RIP 240 is connected to a USB port of the target server 240, then the RIP will be powered by the USB port and will respond to communications from the appliance.) Similarly, in a configuration such as is shown in FIG. 2B, when a monitoring device 285 detects that a target server 120 has powered up, the monitoring device will be able to communicate with the server management appliance 260 over a communications channel 245. In either configuration, the server management appliance 260 can then be used to correlate which outlet of the remote power switch 200 recently had power applied to it so that a correlation between target server/RIP can be recorded (e.g., in a network database) so that that particular target server/RIP may be restarted or power cycled at a later time, if required. This correlation can be made without requiring that a person manually make an association between outlets of a remote power switch and a target server.

For servers with multiple power supplies, it may be necessary to turn on each of the power supplies separately while the others remain off. For example, with all of the power outlets turned off, a first outlet is powered on, and its correlation with a target server monitoring device is determined. The server connected to the first outlet is then powered down. Each of the other outlets is then powered on in turn (with the others off), its correlation determined with a server, and then the corresponding server is powered down. When a correlation indicates that a server is already known to be connected to another outlet also, then the system will know that the server has multiple power supplies and can use that information later if all the power supplies to that server are to be cycled (e.g., as might need to happen when the server has “crashed” or is otherwise no longer responsive). By identifying each of the outlets separately by their information tag 215, the system can track how many outlets are used by each server, which server each outlet is connected to and whether a power cord has been moved from one outlet to another. Thus, the process of tracking the correlations between servers and their target server monitoring devices can be run periodically (e.g., when servers are being restarted for maintenance), and the correlation data can be periodically updated/refreshed.

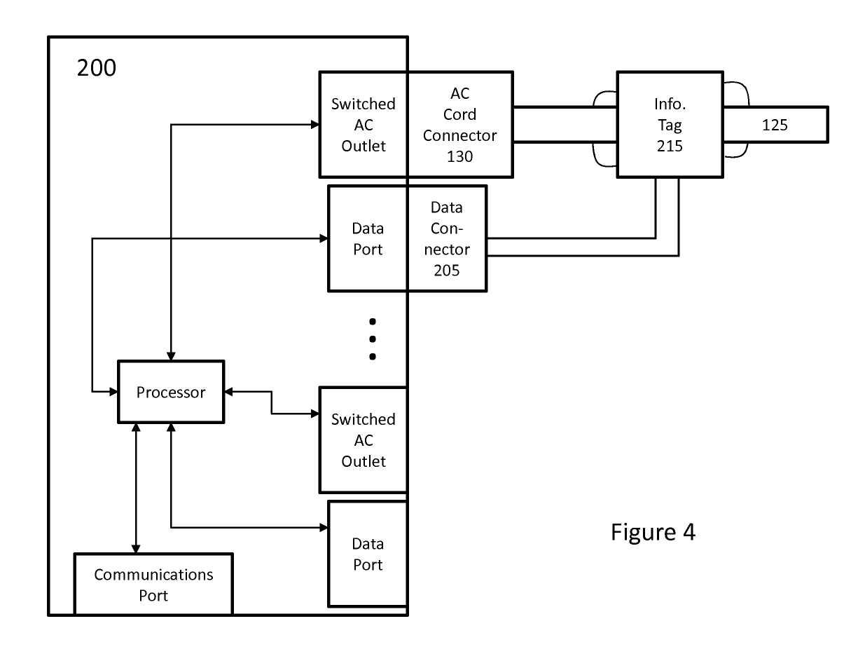

As shown in greater detail in FIG. 4, a remote power switch 200 includes a data port and a switched AC outlet per target server to which the remote power switch 200 is attached. A processor (or other programmed or programmable logic circuits, all of which will generally be referred to herein as a “processor”) controls switching power on and off to individual outlets. In addition, at least one data port of the remote power switch 200 enables communication between an information tag 215 and the switch 200. The information tag 215 is affixed or connected (e.g., using tie wrap or cable tie) to the remote power switch end of the power cord 125. The information tag 215 is further connected to the remote power switch 200 using a data connector 205 which enables communication between the information tag 215 and the remote power switch 200. The connection of the information tag 215 to the data connector 205 can be made by a cable of two or more wires that carry power and/or data. Alternatively, the information tag 215 can connect to the remote power switch 200 using wireless communication (e.g., infra-red or RF communication). Similarly, powerline communication can be used to transmit information between the information tag 215 and the remote power switch 200.

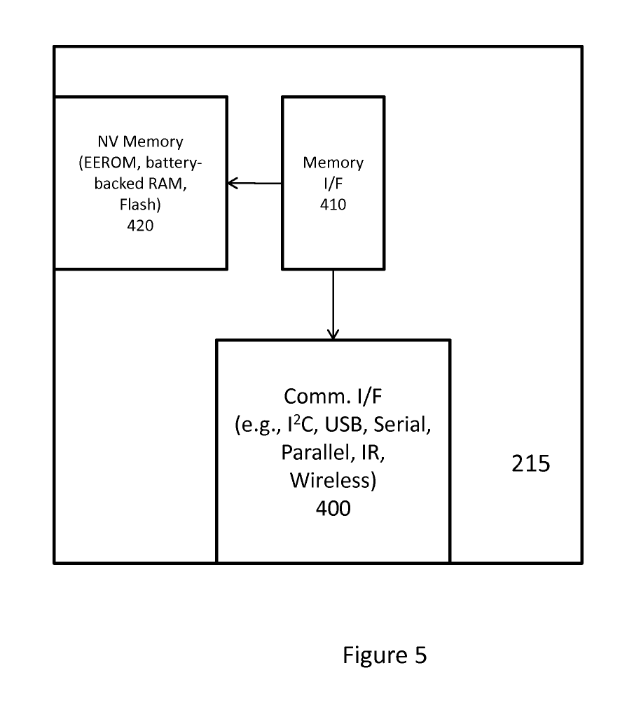

As shown in FIG. 5, an information tag 215 includes a communications interface 400 for handling communication between the remote power switch 200 and the information tag 215. It further includes a memory interface 410 for controlling access by the communications interface 400 to the non-volatile memory 420. The non-volatile memory can be any memory that does not lose its contents when power is not being supplied via the circuits in data connector 205. For example, the memory 420 can include EEPROM, ROM, battery-backed RAM, Flash memory, and ferroelectric memory. The memory may either be pre-programmed with an identifier that uniquely identifies the information tag 215 (such as would occur in a ROM) or may be programmed when the information tag 215 is first determined to be non-programmed by a connected switch 200 as could be done with EEPROM or battery-backed RAM.

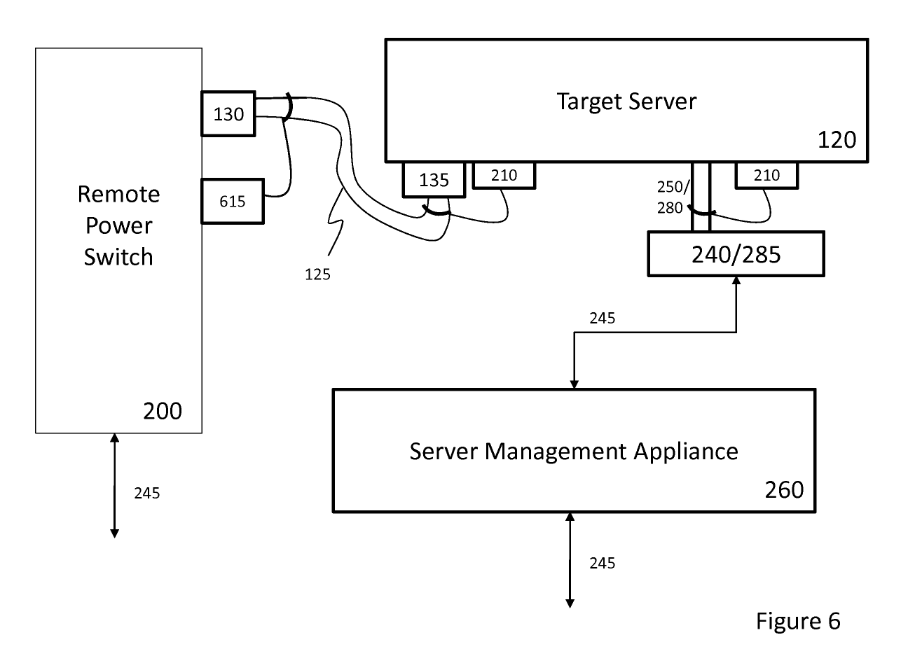

In an alternate embodiment, the data connector 205 and the information tag 215 can be combined into a single integrated information tag 615. The integrated information tag 615 can be connected to the power cord 125 at the switch-end by way of a short lanyard wrapped around the power cord 125, as shown in FIG. 6. Alternatively, the integrated information tag 615 can be connected to the power cord 125 at the remote power switch-end by way of a short lanyard connected to a flange in the switch-end of the power cord 125, as shown in FIG. 7. In either of these embodiments, the integrated information tag 615 can be implemented as a small capacity USB-drive with an attachment point (e.g., ring) for attaching a lanyard to the power cord. The USB drive would then connect to a standard USB port on the remote power switch which could provide power and data to the USB drive.

The operation of the remote power switch 200 will now be described with reference to FIG. 4. Periodically, the processor of the switch 200 will query each of the data ports (either sequentially or in parallel) to determine if an information tag 215/615 has been connected to a data port since the last set of queries. If a new, non-programmed information tag 215/615 is determined to be newly connected to the switch 200, the switch 200 can cause the memory interface 410 to write a unique identifier to the memory that can then be queried later (and associated with a target server) to which it is known to be connected. To ensure that the identifier is unique, each switch may be assigned a unique serial number (e.g., its MAC address) and append a counter value (stored in non-volatile memory) to the serial number. The counter value is then increased before being used in the next unique identifier. For example, a switch with a unique serial number of 0x12345678 (where 0x signifies hexadecimal notation) which creates its first unique identifier could create a unique identifier of: 0x1234567800000000. The next unique identifier created by the same switch could then be: 0x1234567800000001.

In an embodiment where the information tag 215/615 is implemented as a USB-drive style device, the switch 200 may simply query the USB drive for a file of a well-known name and, if the file is not found, the information tag 215/615 is considered to be non-programmed. The switch 200 then writes the file to the USB drive where the file has the unique identifier stored in it, either in text or binary form, and in either encrypted or unencrypted format.

In the case that the switch 200 attempts to read the file with the well-known name from the USB drive and finds it, then the switch knows that the information tag 215/615 is a programmed tag and can read the serial number from the file.

In yet another embodiment, the USB-drive style device is just a non-volatile memory connected using a USB connector that can have an ID written to it and read from it, without support for a filesystem.

When the unique identifier of an information tag 215 has been correlated to an outlet of the switch 200, the switch 200 can report the unique identifier and the outlet information to the server management appliance 260 (or to a server management system) using the at least one communications channel 245.

In an alternate embodiment, the tag 215 is connected to the switch 200 using an I²C interface. In such a configuration, the tag 215 can be powered by utilizing the clock signal as a power source which is then rectified (e.g., using a diode and a capacitor). The data line is then able to provide the communication between the switch 200 and the tag 215/615. Other communications interfaces include Manchester and SPI-based interfaces.

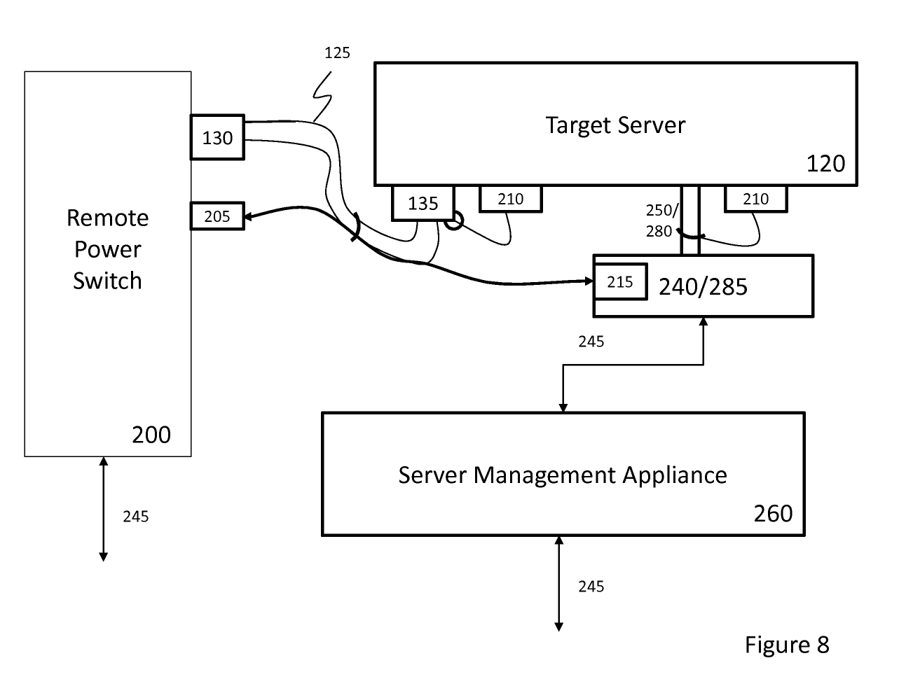

As shown in FIG. 8, the information tag 215 can also be incorporated into the RIP 240 such that the power switch 200 and the RIP 240 are directly connected. In such an embodiment, in order to reduce the risk that cables will be incorrectly associated between the switch 200, the target server 120 and the RIP 240, an integrated bundle of cables can be used.

In an embodiment where the RIP 240 is connected to the target server 120 using a USB cable, the RIP 240 can also utilize remote media capabilities so that information can be read from the RIP by the target server or read from the target server by the RIP. In this way, the target server and its associate RIP can track their corresponding connections and report if those connections change.

While certain configurations of structures have been illustrated for the purposes of presenting the basic structures of the present invention, one of ordinary skill in the art will appreciate that other variations are possible which would still fall within the scope of the appended claims. For example, the communications channels 245 need not be all the same within a system, and the communication protocols used to communicate between the various components described herein need not be the same either. Furthermore, while target servers have been described as being connected to the remote power switch 200, other target devices can be connected as well. For target devices that are not connected to a RIP, the information tag can instead be preprogrammed with information about the target device such that the remote power switch 200 can know what is connected to the switched AC outlet corresponding to the data port of the information tag.

1. A system for identifying wiring connections of target devices, the system comprising:
a remote power switch including plural data ports and plural switched AC outlets; and
at least one information tag connected to a first data port of the plural data ports and associated with an AC power cord connected to a first switched AC outlet of the plural AC outlets associated with the first data port.

2. The system as claimed in claim 1, wherein the at least one information tag is attached to the AC power cord connected to the first switched AC outlet using a mechanical bonding device.

3. The system as claimed in claim 1, wherein the at least one information tag is attached to the AC power cord connected to the first switched AC outlet using a lanyard.

4. The system as claimed in claim 1, wherein the remote power switch reads a unique identifier from the at least one information tag.

5. The system as claimed in claim 1, wherein the remote power switch writes a unique identifier to the at least one information tag if the at least one information tag does not contain a unique identifier.

6. The system as claimed in claim 1, wherein the remote power switch and the at least one information tag communicate using an I²C interface.

7. The system as claimed in claim 1, wherein the remote power switch and the at least one information tag communicate using a USB interface.

8. The system as claimed in claim 1, wherein the remote power switch and the at least one information tag communicate using a SPI interface.

9. The system as claimed in claim 1, wherein the remote power switch and the at least one information tag communicate using a Manchester interface.

10. The system as claimed in claim 1, further comprising a rack interface pod for connecting to a first target device of the plural target devices, wherein the power cord is connected to the first target device and wherein the rack interface pod sends a message to a management device when the first target device is powered up.

11. The system as claimed in claim 10, wherein the rack interface pod sends the message to a server management appliance.

12. The system as claimed in claim 10, further comprising a bonding device for connecting the rack interface pod to the first target device.

13. The system as claimed in claim 12, wherein the first target device is a first target server.

14. The system as claimed in claim 10, wherein the remote power switch further comprises a communications interface for receiving a request to cycle the power to the first switched AC outlet, and wherein the rack interface pod sends the message to the management device after power is restored to the first target device.

15. The system as claimed in claim 2, wherein the mechanical bonding device comprises a tie-wrap.

16. The system as claimed in claim 1, further comprising a monitoring device for connecting to a first target device of the plural target devices, wherein the power cord is connected to the first target device and wherein the monitoring device detects when the first target device is powered up.

17. The system as claimed in claim 16, wherein the monitoring devices sends a message to a management device when the monitoring device detects that the first target device has powered up.
